(19) United States
(12) Patent Application Publication
(10) Pub. No.: US 2009/0139360 A1
(43) Pub. Date: Jun. 4, 2009

(54) JOYSTICK ATTACHMENT

(75) Inventor: Amory R. Diccion, Dunlap, IL (US)

Correspondence Address: Caterpillar Inc.;Intellectual Property Dept., AH 9510, 100 N.E. Adams Street, PEORIA, IL, 61629-9510, US

(73) Assignee: CATERPILLAR INC, Peoria, IL (US)

(21) Appl. No.: 11/948,382

(22) Filed: Nov. 30, 2007

(51) Int. Cl. G05G 9/047

(52) U.S. Cl. 74/471 XY

(57) ABSTRACT

A joystick attachment that may be attached to a joystick that includes a grip portion pivotally attached to and extending from a base portion. The joystick attachment includes an engagement portion affixable to the grip portion of the joystick and a control portion supporting at least one input device and connected to the engagement portion.

### TECHNICAL FIELD

This invention relates generally to a joystick attachment for a joystick, and more specifically, for providing additional input devices in convenient proximity to an existing joystick.

### BACKGROUND

As new technologies become available, they may be added to existing and new machines to improve their functionality, efficiency, and general usefulness. However, this new technology may not be easily accessed by an operator of the machine because the existing controls of the machine are allocated for other functions. Instead, controls for the new technology may be disposed remotely from the operator in inconvenient or distracting locations. Further, this positioning can vary significantly between machines of the same and different designs. This variation may slow an operator's familiarization of a machine and result in wasted time and higher operation costs.

The present invention is directed to overcome one or more of the problems as set forth above.

### SUMMARY OF THE INVENTION

In one example, a joystick attachment for a joystick having a grip portion pivotally attached to and extending from a base portion is provided. The joystick attachment includes an engagement portion that may be affixed to the grip portion of the joystick. The joystick attachment also includes a control portion connected to the engagement portion. The control portion supports at least one input device.

A method of expanding the functionality of a joystick including a grip portion pivotally attached to and extending from a base portion is provided. The method may include providing a joystick attachment. The joystick attachment may include an engagement portion and a control portion connected to the engagement portion. The control portion may support at least one input device. A data cable terminating in a connector may be electrically connected to the input device.

The method may also include affixing the engagement portion to the joystick such that the joystick attachment moves with actuation of the grip portion of the joystick. Further, the joystick may be electrically connected to an electronic control unit so that the method also includes coupling the connector to an electronic control unit.

### BRIEF DESCRIPTION OF THE DRAWINGS

FIG. 1 is an isometric view of an operator compartment of a machine illustrating joystick attachments respectively affixed to a right-hand joystick and a left-hand joystick.

FIG. 2 is an isometric view of the joystick attachment shown in FIG. 1.

FIG. 3 is a left side view of the joystick attachment shown in FIG. 1.

FIGS. 4A and 4B are partial isometric views of the joystick attachment and hand support structure of the grip portion of the joystick of FIG. 2.

FIG. 5 is a partial isometric view of an alternative engagement portion of the joystick attachment shown in FIG. 2.

FIG. 6 is a partial isometric view of another alternative engagement portion of the joystick attachment shown in FIG. 2.

FIG. 7 is an isometric view of another joystick attachment.

FIG. 8 is an exploded view of a control portion and a section of the neck portion of the joystick attachment shown in FIG. 6.

FIG. 9 is a front view of yet another joystick attachment.

FIG. 10 is a top view of the joystick attachment of FIG. 9.

### DETAILED DESCRIPTION

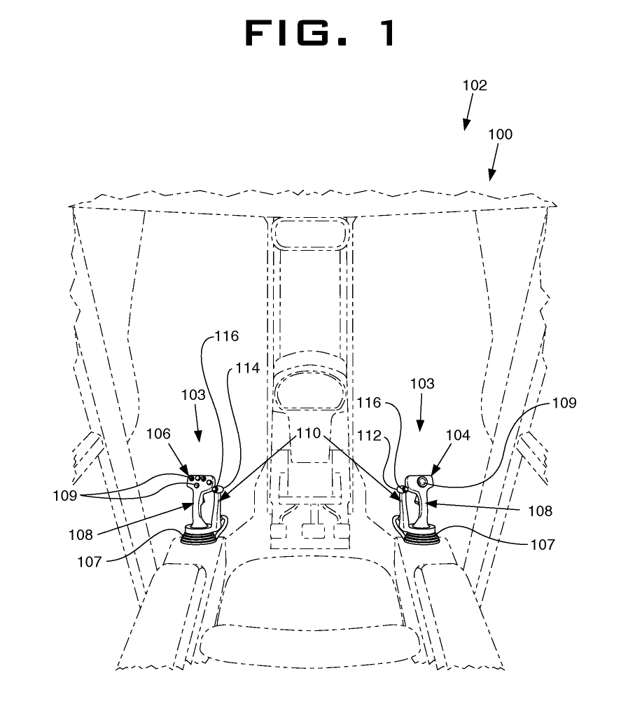

Referring to FIG. 1, an isometric view illustrates an operator compartment 100 of a machine 102. The machine 102 may be, but is not limited to, a motor grader, an excavator, a track-type tractor, a wheel loader, a tracked loader, an off-highway truck, a material handler, or any other machine having an operator compartment. As shown, the operator compartment 100 may include joysticks 103 such as a right-hand joystick 104 and a left-hand joystick 106.

The right-hand joystick 104 and the left-hand joystick 106 each include a base portion 107 and a grip portion 108 pivotally attached to and extending from the base portion 107. The grip portion 108 may include one or more input devices 109 that may be actuated by an operator. The input devices 109 may be designated to control specific functions of the machine 102.

As shown, one or more joystick attachments 110 may be affixed to the joysticks 103. In this configuration, a right-hand joystick attachment 112 and a left-hand joystick attachment 114 may be attached to the respective right-hand and left-hand joysticks 104,106.

Specifically, the joystick attachments 110 permit additional input devices 116 to be positioned for convenient actuation by an operator. For example, the joystick attachments 110 may facilitate an upgrade or retrofit an existing machine with additional functionality and in some cases, newer technology. Alternatively, the joystick attachments 110 may be used to more conveniently position input devices 116 according to operator preferences than the input devices 109 that are integrated into the right-hand joystick 104 and the left-hand joystick 106.

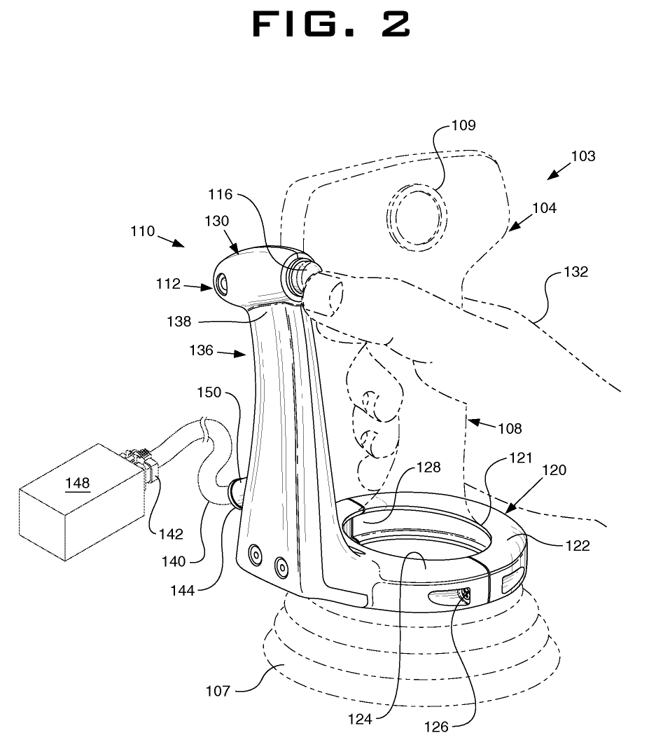

Referring to FIG. 2, an isometric view illustrates a joystick attachment 110 affixed to the joystick 103. As shown, the joystick attachment 110 may be selectively affixed to a joystick 103 (shown in phantom) by attaching an engagement portion 120 of the joystick attachment to the grip portion 108 of the joystick 103.

The engagement portion 120 engages the grip portion 108 so that the joystick attachment 110 moves with actuation of the grip portion 108 of the joystick 103. More specifically, the engagement portion 120 may be configured to attach to a hand support structure 121 of the grip portion 108 of the joystick 103. The engagement portion 120 permits the joystick attachment 110 to be connected to existing joysticks 103 of machines 102 (shown in FIG. 1).

In this configuration, the engagement portion 120 may include a first part 122 selectively movable relative to a second part 124 in order to receive and grip the hand support structure 121. As shown, the first part 122 and the second part 124 may be removably attached together via mechanical fasteners 126 and cooperate to provide a circular or noncircular receiving surface 128 that engages the grip portion 108 for secure attachment.

The joystick attachment 110 may also include a control portion 130 supporting at least one input device 116 and connected to the engagement portion 120. The control portion 130 positions and orients the at least one input device 116 so that it may be conveniently actuated by a hand 132 of an operator that is also gripping the joystick 103. The input device 116 may be any type of input device known in the art, such as a push button, a switch, a lever, a roller, a key pad, or touch pad.

A neck portion 136 may connect the control portion 130 with the engagement portion 120. More specifically, the neck portion 136 may extend from the engagement portion 120 and the control portion 130 may be attached to a distal end 138 of the neck portion 136. The neck portion 136 may extend generally parallel to the grip portion 108 of the joystick 103 and position the control portion 130 at a distance from the engagement portion 120 for convenient actuation by the hand 132. To do this, the neck portion 136 may extend at least one inch. In other configurations, the neck portion 136 may extend more than two inches from the engagement portion 120, while in others; the neck portion 136 may extend more than three inches from the engagement portion 120.

Additionally, the joystick attachment 110 may include a data cable 140 electrically connected to the input device 116 and terminating in a connector 142. In configurations that include the data cable 140, the neck portion 136 may include an exterior opening 144. The data cable 140 may extend from the input device 116 at least partially through the neck portion 136 and out the exterior opening 144.

Once the joystick attachment 110 is affixed to the joystick 103, the connector 142 may be coupled with an electronic control unit 148. The electronic control unit 148 may be part of the machine 102 or a new controller for providing new functionality to the machine 102.

Instead of the data cable 140, the joystick attachment 110 may include a wireless transmitter (not shown) for transmitting the actuation of the input device 116 to the electronic control unit 148.

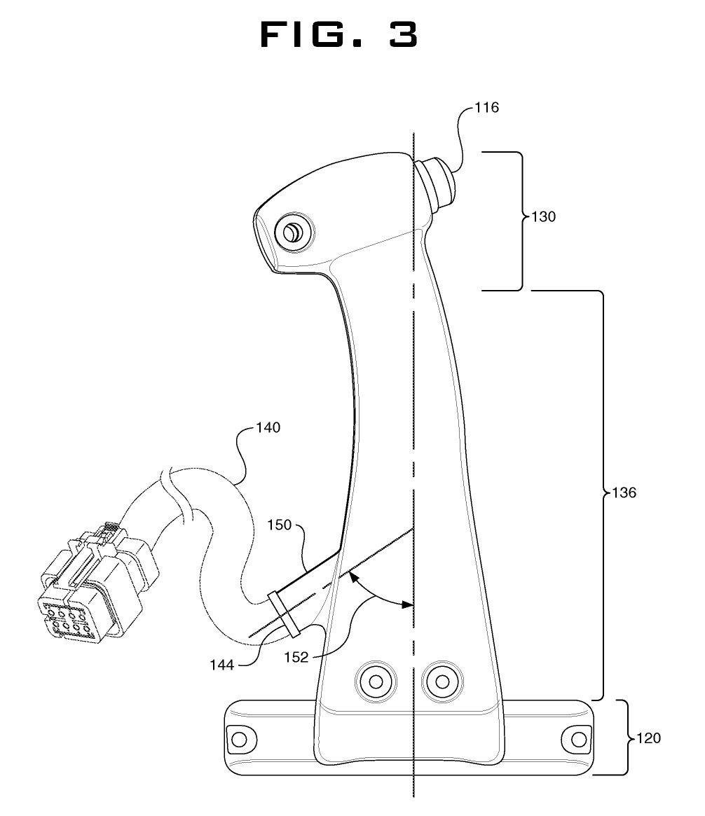

Referring to FIG. 3, the exterior opening 144 may include an annular extension 150 extending from the neck portion 136. The annular extension 150 may extend downward at an angle 152 between ten degrees and ninety degrees to the neck portion 136. Alternatively, the annular extension 150 may extend downward at the angle 152 between twenty-five degrees and sixty-five degrees to the neck portion 136.

In some configurations, the annular extension 150 may be attached to the data cable 140 and thus, act as a stress relief to prevent disruption of the electrical connection between the at least one input device 116 and the data cable 140. Additionally, the annular extension 150 may position the data cable 140 away from the operator to prevent inadvertent contact.

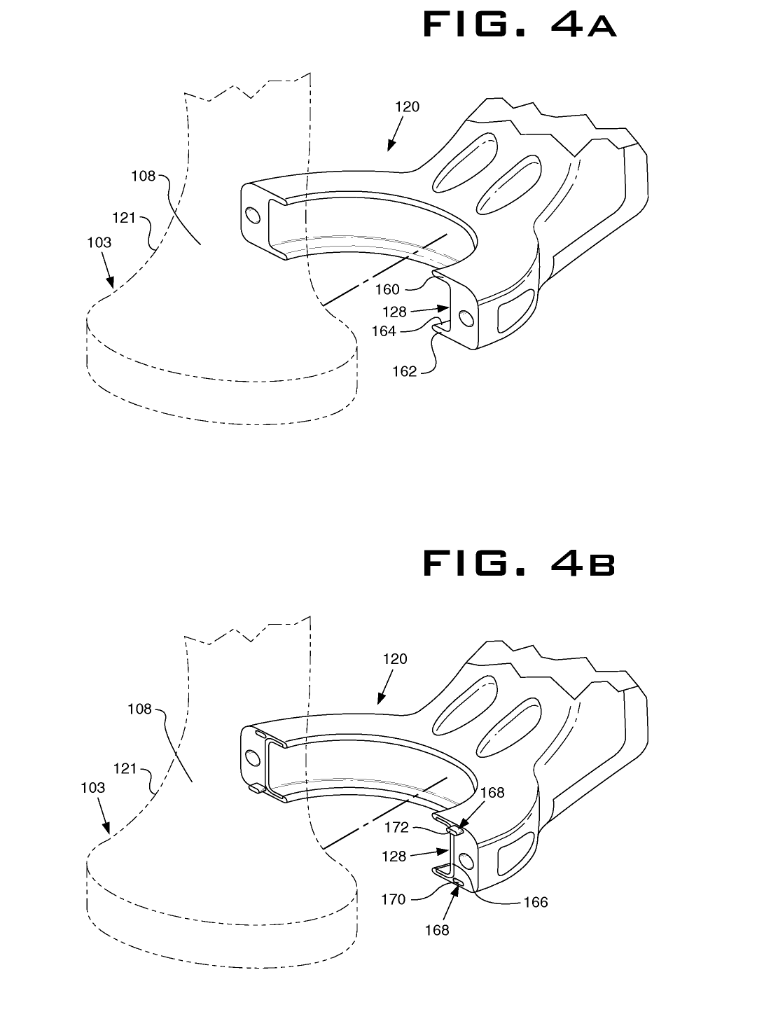

Referring to FIG. 4A, a partial isometric view illustrates the engagement portion 120 of the joystick attachment 110 and hand support structure 121 of the grip portion 108 of the joystick 103. As shown, the engagement portion 120 may have a C-shaped cross-sectional profile such that the hand support structure 121 is disposed between an upper extension 160 and a lower extension 162 when secured by the engagement portion 120. Additionally, the receiving surface 128 may include a surface coating 164 to increase the friction between the engagement portion 120 and the grip portion 108. For example, the surface coating 164 may be an elastomer such as a natural or synthetic rubber.

Referring to FIG. 4B, a partial isometric view illustrates an alternative configuration of the engagement portion 120. As shown, the receiving surface 128 may include a foam or elastomeric liner 166 that may be compressed against the grip portion 108 when the hand support structure 121 is secured by the engagement portion 120. This compression of the foam or elastomeric liner 166 assists in the engagement portion 120 gripping the hand support structure 121 to prevent rotation around joystick 103 shown in FIG. 2. Further, the foam or elastomeric liner 166 may mold to and secure the grip portion 108. The foam or elastomeric liner 166 may be made of any polymer, composite, plastic, or rubber known in the art.

Optionally, the engagement portion 120 may include alignment keys 168 that may assist in the attachment of the first part 122 with second part 124. The alignment keys 168 may include a receiving slot 170 and/or a mating extension 172 that mate with reciprocal alignment keys (not shown) in the other of the first part 122 and second part 124.

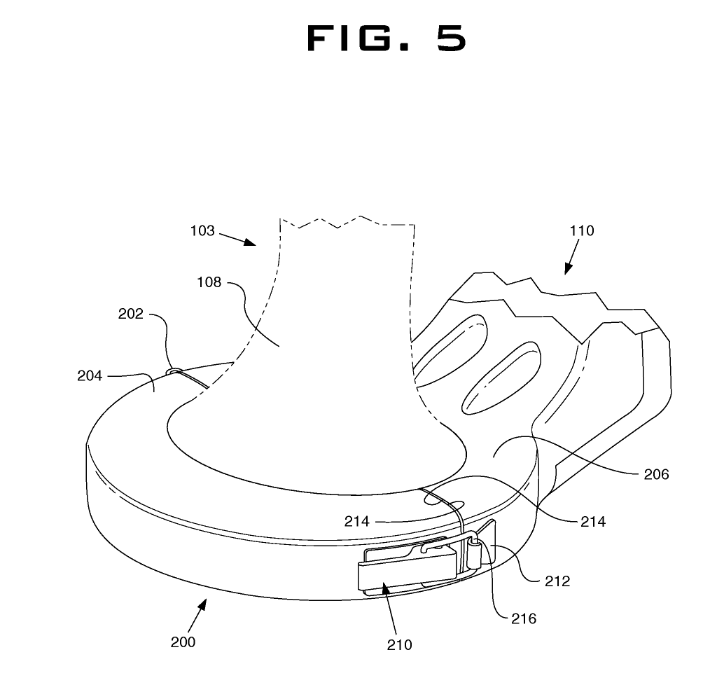

Referring to FIG. 5, a partial isometric view illustrates an alternative engagement portion 200 of the joystick attachment 110 of FIG. 2. As shown, the engagement portion 200 may include a hinge 202 for pivotally moving a first part 204 relative to a second part 206 in order to receive a grip portion 108 of the joystick 103.

The engagement portion 200 may also include a linkage 210 and a hook 212 for clamping the distal ends 214 of the first part 204 with second part 206 nearer each other in order to secure the engagement portion 200 to the grip portion 108. As shown, the linkage 210 may be extended to engage the hook 212 with pin 216. Then, the linkage 210 may be collapsed to pull the hook 212 and pin 216 closer to the distal end 214 of the first part 204 and clamp the distal ends 214 nearer each other.

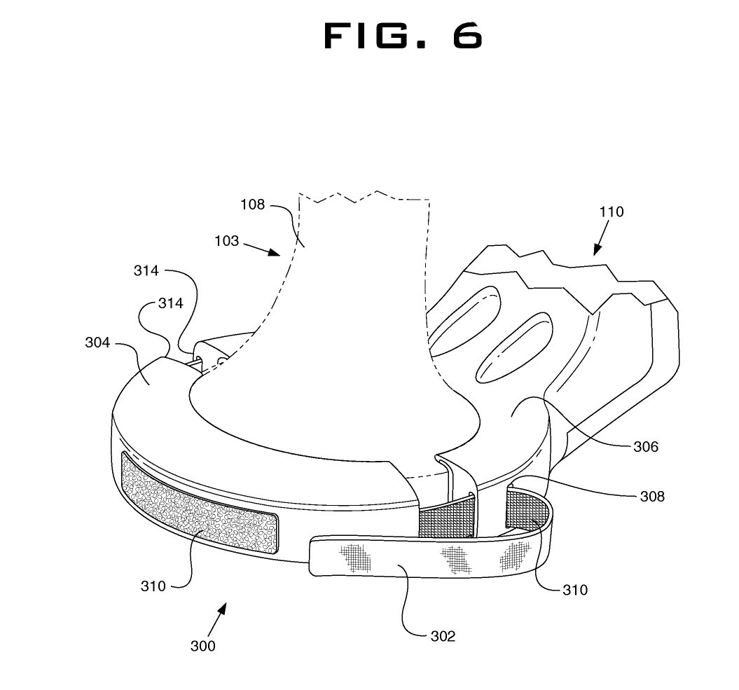

Referring to FIG. 6, a partial isometric view illustrates another alternative engagement portion 300 of the joystick attachment 110 of FIG. 2. As shown, a strap 302 may extend through a first part 304 and be attached to the second part 306. Additionally, a plurality (not shown) of first parts 304 may be provided to engage the grip portion 108 at additional locations. Once the first part 304 and second part 306 are engaging the grip portion 108 of the joystick 103, the strap 302 may be looped through a hoop 308 and secured to itself 302 via a hook and loop fastener 310.

The strap 302 may be made of wire, natural fibers, synthetic fibers, a metal linkage, plastic, leather, or any other material that may be formed into a flexible structure. Additionally, other securing means may be provided such as the linkage 210 and hook 212 (shown in FIG. 5), a mechanical fastener 126 (shown in FIG. 2), an adhesive (not shown), a clamp (not shown), or any other means for securing the first part 304 and the second part 306 to the grip portion 108 of the joystick 103.

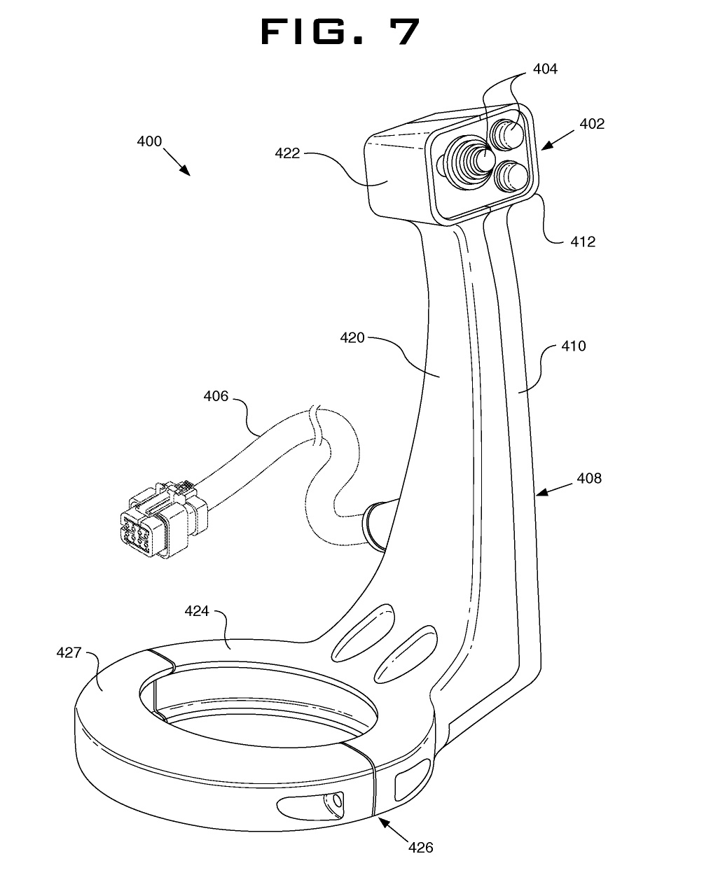

Referring to FIG. 7, an isometric view illustrates another joystick attachment 400. The joystick attachment 400 has many similar features to the joystick attachment 110 of FIG. 2, which will not be discussed in detail. As shown, the control portion 402 of the joystick attachment 400 may include a plurality of input devices 404. Each input device 404 may be electrically connected with the data cable 406.

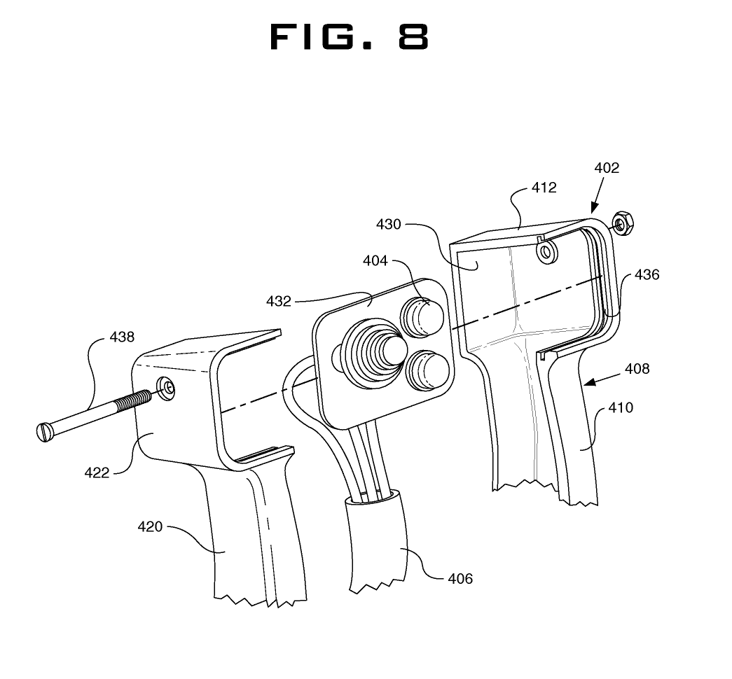

In this configuration, the neck portion 408 may include a first section 410 that may be unitarily formed with a first housing 412 of the control portion 402. The neck portion 408 may also include a second section 420 that may be unitarily formed with a second housing 422 of the control portion 402 and a second part 424 of the engagement portion 426. Like the joystick attachment 110 of FIG. 2, a first part 427 of the engagement portion 426 may be movable relative to the second part 424 and cooperate to receive and grip a grip portion of a joystick (not shown). As is shown in FIG. 8, the first and second sections 410, 420 and the respectively connected first and second housings 412, 422 may be detached and separated.

Referring to FIG. 8, an exploded view illustrates the separated first and second sections 410, 420 of the neck portion 408 and the first and second housings 412, 422 of the control portion 402. As shown, the data cable 406 may extend through a cavity 430 extending through the neck portion 408 and control portion 402 to terminate at a faceplate 432. The faceplate 432 may include a circuit board (not shown) mounted to a rear face of the faceplate 432 and a connector (not shown) for facilitating connection of the data cable 406. The input devices 404 may be mounted on the faceplate 432 and electrically connected to the data cable 406.

The faceplate 432 may be mounted in the in the first and second housings 412, 422. A different faceplate having different input devices may be mounted in the first and second housings 412, 422 in order to provide modularity of input devices 404 to the joystick attachment 400. The faceplate 432 may be secured in the first and second housings 412, 422 by being placed in the retaining ridge 436 and attaching the first and second housings 412, 422 with a mechanical fastener 438. Alternatively, the first and second housings 412, 422 may be attached by an adhesive or sonically welded.

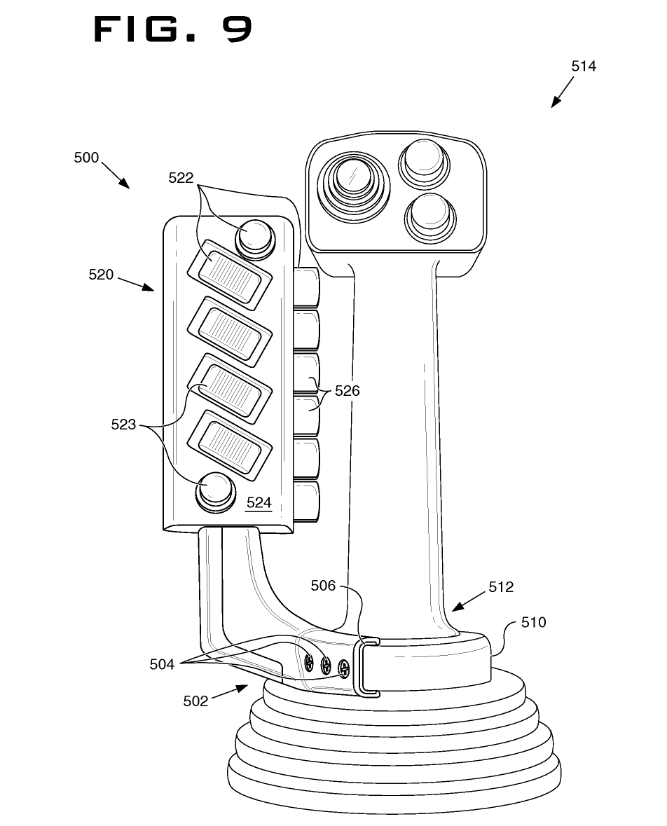

Referring to FIG. 9, a front view illustrates yet another configuration of a joystick attachment 500. As shown, the engagement portion 502 may include a plurality of mechanical fasteners 504 and a foam or elastomeric liner 506 engaging the hand support structure 510 of the grip portion 512 of the joystick 514.

The control portion 520 may include a plurality of input devices 522. A first group 523 of the input devices 522 may be disposed on a front surface 524 of the control portion 520 for convenient actuation by a thumb 525 of a hand 526 gripping the joystick 514.

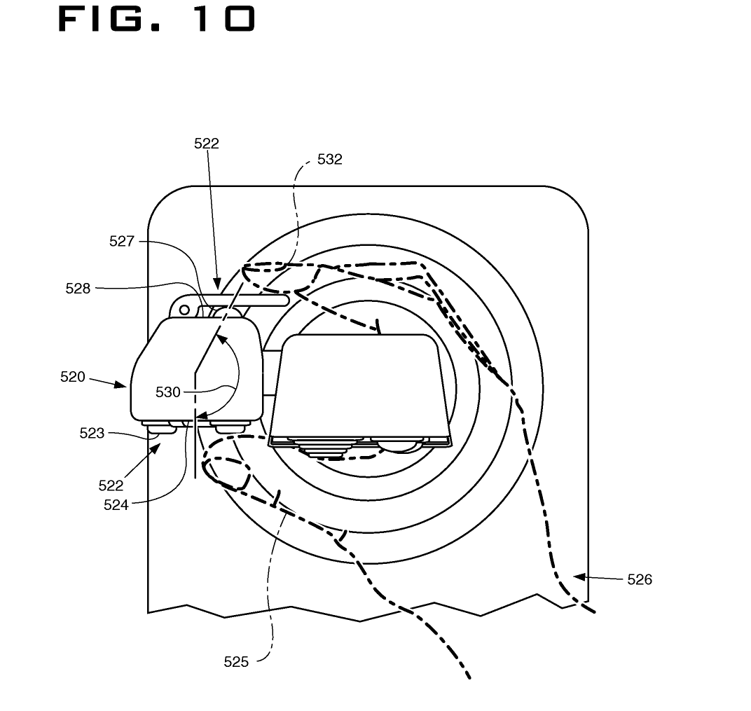

Referring to FIG. 10, a top view of the control portion illustrates that a second group 527 of the input devices 522 may be disposed on another surface 528, such as a rear or side surface, of the control portion 520. In other words, the second group 527 may be disposed at an angle 530 radially about the control portion from the first group 523 of input devices 522. In some configurations, the second group 527 may be disposed more than or equal to about ninety degrees radially about the control portion from the first group 523 of input devices 522. This positioning of the second group 527 of input devices 522 may provide for convenient actuation by the fingers 532 of the hand 526 gripping the joystick 514.

### INDUSTRIAL APPLICABILITY

The joystick attachment may be used to expand the functionality of a joystick including a grip portion pivotally attached to and extending from a base portion and being electrically connected to an electronic control unit. Specifically, a joystick attachment may be provided. As described above, the joystick attachment may include an engagement portion and a control portion connected to the engagement portion. The control portion may support at least one input device that may be electrically connected to a data cable terminating in a connector.

The engagement portion may be affixed to the joystick such that the joystick attachment moves with actuation of the grip portion of the joystick. In configurations where the engagement portion includes an elastomer or foam, the elastomer or foam may be compressed against a section of the grip portion of the joystick. This compression may provide a secure attachment of the joystick attachment to the grip portion of the joystick. Additionally, the connector may be coupled to the electronic control unit.

In configurations where the joystick attachment includes a neck portion connecting the engagement portion with the control portion, the control portion may be oriented relative to the grip portion for actuation of the at least one input device by a digit of a hand gripping the joystick. Further, where a plurality of input devices may be included in the control portion and a first group is disposed on a first surface and a second group of input devices is disposed more than ninety degrees radially about the control portion from the first group of input devices, the joystick attachment may be oriented to dispose the first group of input devices for actuation by a thumb of a hand gripping the joystick and the second input device for actuation by a finger of the hand gripping the joystick.

It will be apparent to those skilled in the art that various modifications and variations can be made without departing from the scope or spirit of the invention. Additionally, other embodiments of the invention will be apparent to those skilled in the art from consideration of the specification and practice of the invention disclosed herein. It is intended that the specification and examples be considered as exemplary only.

What is claimed is:

1. A joystick attachment for a joystick including a grip portion pivotally attached to and extending from a base portion, the joystick attachment comprising:
an engagement portion selectively affixable to the grip portion of the joystick; and
a control portion supporting at least one input device and connected to the engagement portion.

2. The joystick attachment of claim 1, further comprising a neck portion connecting the engagement portion with the control portion.

3. The joystick attachment of claim 2, further comprising a data cable terminating in a connector, the data cable being electrically connected to the at least one input device.

4. The joystick attachment of claim 3, wherein the neck portion includes an exterior opening, wherein the data cable extends at least partially through the neck portion and through the exterior opening.

5. The joystick attachment of claim 4, wherein the exterior opening includes an annular extension extending from the neck portion.

6. The joystick attachment of claim 5, wherein the annular extension extends downward at an angle between ten degrees and ninety degrees to the neck portion.

7. The joystick attachment of claim 2, wherein the neck portion extends generally parallel to the grip portion of the joystick.

8. The joystick attachment of claim 2, wherein the neck portion extends at least one inch.

9. The joystick attachment of claim 1, wherein the engagement portion is configured to attach to a hand support structure of the grip portion of the joystick.

10. The joystick attachment of claim 9, wherein the engagement portion includes a first part movable relative to a second part, wherein the first part and the second part are configured to cooperate to receive and grip the hand support structure of the grip portion of the joystick.

11. The joystick attachment of claim 1, wherein the engagement portion includes a gripping surface comprising an elastomer.

12. The joystick attachment of claim 1, wherein the engagement portion includes a foam that is compressed against the grip portion of the joystick.

13. The joystick attachment of claim 1, wherein the at least one input device is disposed on a front surface of the control portion, the control portion further including a second input device disposed on another surface of the control portion.

14. The joystick attachment of claim 1, wherein the at least one input device is a first input device, wherein the control portion includes a second input device disposed more than or equal to about ninety degrees radially about the control portion from the first input device.

15. A joystick attachment for a joystick including a grip portion pivotally attached to and extending from a base portion, the joystick attachment comprising:
an engagement portion selectively affixable to the grip portion of the joystick, wherein when the engagement portion is attached to the joystick, the joystick attachment moves with actuation of the grip portion of the joystick;
a neck portion extending from the engagement portion;
a control portion attached to a distal end of the neck portion, the control portion supporting at least one input device; and
a data cable terminating in a connector, the data cable being electrically connected to the at least one input device.

16. A method of expanding the functionality of a joystick including a grip portion pivotally attached to and extending from a base portion, the joystick being electrically connected to an electronic control unit, the method comprising:
providing a joystick attachment, the joystick attachment including an engagement portion and a control portion connected to the engagement portion, the control portion supporting at least one input device, and a data cable terminating in a connector, the data cable being electrically connected to the at least one input device;
affixing the engagement portion to the joystick such that the joystick attachment moves with actuation of the grip portion of the joystick; and
coupling the connector to the electronic control unit.

17. The method of claim 16, wherein the joystick attachment further includes a neck portion connecting the engagement portion with the control portion, wherein the neck portion extends from the engagement portion and the control portion is attached to a distal end of the neck portion, the method further comprising orienting the control portion for actuation of the at least one input device by a digit of a hand gripping the joystick.

18. The method of claim 16, wherein the engagement portion includes an elastomer, the method further comprising compressing the elastomer against a section of the grip portion of the joystick.

19. The method of claim 16, wherein the engagement portion includes a foam, the method further comprising compressing the foam against a section of the grip portion of the joystick.

20. The method of claim 16, wherein the at least one input device is a first input device and the control portion includes a second input device disposed more than ninety degrees radially about the control portion from the first input device, wherein the method further comprises orienting the joystick attachment to dispose the first input device for actuation by a thumb of a hand gripping the joystick and the second input device for actuation by a finger of the hand gripping the joystick.
